(19) United States
(12) Patent Application Publication
(10) Pub. No.: US 2026/0098582 A1
(43) Pub. Date: Apr. 9, 2026

(54) SPINDLE ASSEMBLY FOR INSTRUMENTED VALVES

(71) Applicant: Emerson Automation Solutions Final Control US LP, Houston, TX (US)

(72) Inventors: Alex Jennings, Houston, TX (US); Ricardo Garcia, Houston, TX (US); Adam Attig, Houston, TX (US); Devon Tomlinson, Houston, TX (US)

(21) Appl. No.: 19/353,213

(22) Filed: Oct. 8, 2025

Related U.S. Application Data
(60) Provisional application No. 63/718,077, filed on Nov. 8, 2024.
(60) Provisional application No. 63/705,214, filed on Oct. 9, 2024.

(51) Int. Cl. F16K 1/32; F16K 1/02; F16K 37/00

(52) U.S. Cl. CPC F16K 1/32; F16K 1/02; F16K 37/0033

(57) ABSTRACT

A valve spindle stabilizer can include a threaded body configured to be screwed onto an adjustment bolt having a first hole that receives a spindle for axial movement within the first hole. The threaded body can include a second hole that receives the spindle with a smaller hole diameter than the first hole for axial movement of the spindle within the second hole, to allow axial movement of the spindle with reduced lateral play relative to the first hole.

### CROSS-REFERENCE TO RELATED APPLICATIONS

This application claims priority to and incorporates by reference U.S. provisional application no. 63/705,214, filed October 9, 2024, and U.S. provisional application no. 63/718,077, filed November 8, 2024.

### BACKGROUND

The disclosed technology pertains to valve systems and their components. Pressure relief valves, including spring-operated pressure relief valves can help control the pressure within a system by allowing over-pressurized fluid to flow from an auxiliary passage out of the system. The lift of these and other valves can be an important parameter in assessing valve functionality or other system factors, and can be measured using digital position transmitters or other sensors. In particular, the “lift” of a valve refers to the distance the valve disk moves away from the closed position, which may correspond to an axial movement of an attached spindle. Valve lift (e.g., measured as a percentage of total possible lift) can determine the flow rate of fluid through the valve.

### SUMMARY

In some examples, the present invention can provide a valve spindle stabilizer that effectively guides a spindle to reduce (e.g., eliminate) lateral play of the spindle that may negatively impact lift measurements (e.g., lift percentage measurement from a position transmitter). Such as stabilizer, for example, can offer a simple yet effective way to enhance the accuracy and repeatability of the lift measurements.

Some examples can provide a valve spindle stabilizer that is easily attachable to the adjustment bolt via internal threads. This feature can allow for quick and easy installation, reducing the downtime associated with valve maintenance and adjustments.

In some examples, a valve spindle stabilizer can allow a spindle to move axially, relatively freely, while essentially eliminating lateral play. This arrangement can provide a more precise prescribed path for the spindle's movement, thereby improving the accuracy and repeatability of the lift percentage measurement.

In some examples, valve spindle stabilizer can include a threaded body configured to be screwed onto an adjustment bolt having a first hole that receives a spindle for axial movement within the first hole. The threaded body can include a second hole that receives the spindle with a smaller hole diameter than the first hole for axial movement of the spindle within the second hole, to allow axial movement of the spindle with reduced lateral play relative to the first hole.

In some examples, a valve assembly can include a valve bonnet and an adjustment bolt coupled to the valve bonnet. A spindle can be axially movable within the valve bonnet and the adjustment bolt. A spindle stabilizer can be attached to the adjustment bolt and can guide axial movement of the spindle.

In some examples, a spindle assembly for an instrumented valve can include an adjustment body, a spindle, and a stabilizer collar. The adjustment body can be secured to a valve bonnet and can include a central bore. A spindle can extend through the central bore of the adjustment body to move axially within the central bore to open and close the instrumented valve. A stabilizer collar can be secured to the adjustment body and can define a stabilizer bore smaller in diameter than the central bore of the adjustment body. The spindle can further extend through the stabilizer bore of the stabilizer collar to move axially to open and close the instrumented valve.

In some examples, the adjustment body can be an adjustment bolt. An internal thread of the stabilizer collar can engage an external thread of the adjustment bolt to secure the stabilizer collar to the adjustment body.

In some examples, the stabilizer collar can include an internal shoulder that seats on a free end of the adjustment bolt to define an installed orientation of the stabilizer collar relative to the adjustment bolt.

In some examples, an instrumented valve can include a valve bonnet and an adjustment bolt secured to the valve bonnet, the adjustment bolt including a central bore. A stabilizer collar can be secured to the adjustment body and can define a stabilizer bore smaller in diameter than the central bore of the adjustment body. A spindle can extend through the central bore of the adjustment bolt and the stabilizer bore to move axially to open and close the instrumented valve within the valve bonnet. The spindle can be blocked from an angular deflection within the central bore by contact with inner walls of the stabilizer bore. A sensor target can be secured to the spindle on an axially opposite side of stabilizer collar from the adjusting bolt. A sensor array can be arranged to detect a location or a movement of the sensor target during axial movement of the spindle.

A method of instrumenting a valve can include securing a stabilizer collar to an adjustment body of the valve, so that a spindle of the valve extends axially through a stabilizer bore of the stabilizer collar and a central bore of the adjustment body to actuate the valve, the stabilizer bore being smaller in diameter than the central bore. A sensor target can be secured to the spindle. A sensor array can be arranged to detect a location or a movement of the sensor target during axial movement of the spindle within the stabilizer and central bores.

The foregoing paragraphs have been provided by way of general introduction and are not intended to limit the scope of the following claims. The embodiments described, together with further advantages, will be best understood by reference to the following detailed description taken in conjunction with the accompanying drawings.

### BRIEF DESCRIPTION OF DRAWINGS

FIG. 1 illustrates a spindle assembly of an instrumented valve;

FIG. 2 illustrates a spindle assembly according to an example of the disclosed technology.

FIGS. 3A and 3B illustrate a stabilizer collar for the spindle assembly of FIG. 2, according to an example of the disclosed technology.

FIGS. 4A and 4B illustrate axonometric and cross-sectional partial views of a valve assembly that includes an example configuration of the spindle assembly of FIG. 2, including the stabilizer collar of FIGS. 3A and 3B.

FIGS. 5 and 6 illustrate cross-sectional partial views of alternate configurations of the spindle assembly of FIG. 2, according to example of the disclosed technology.

FIGS. 7 and 8 are perspective views of an example configuration of a stabilizer collar for the spindle assembly of FIGS. 5 and 6.

### DETAILED DESCRIPTION

Aspects of the disclosed technology are best understood by reference to the description and figures set forth herein. All the aspects described herein will be better appreciated and understood when considered in conjunction with the following descriptions. It should be understood, however, that the following description, while indicating favorable implementations and numerous specific details thereof, are given by way of illustration only and should not be treated as limiting. Changes and modifications may be made to the presented examples without departing from the spirit and scope of the disclosed technology, which includes all such modifications.

In pressure relief valves and other systems, the spindle is generally arranged to move a valve disc to open and close a valve. For example, a vertically oriented spindle can be connected to a valve disc or other sealing assembly to move the disc (or other assembly) up and down, thereby causing the valve to open and close.

Accordingly, it may be useful to measure movement of a spindle (e.g., by measuring a change in position of the spindle over time). However, the reliability of these measurements can be compromised if there is excessive “play” in the spindle, i.e., if the spindle can be excessively deflected during operation, relative to straight axial travel. Such a lateral (or otherwise transverse) movement of a spindle, and the corresponding angular deflection, can cause inaccurate readings and, consequently, poor valve performance or unreliable valve monitoring. In particular, during operation of conventional systems, position readings taken relative to an end of the spindle can be significantly altered (e.g., by 20% or more) due to spindle deflection, which can lead to unreliable lift measurements.

Accordingly, it may be useful to implement stabilizers for spindles of instrumented valves. However, without appropriate design, such a solution may overly restrict the axial movement of a spindle, or may not reduce lateral movement sufficiently. Further, to be practicably implemented on large-scale installations (and elsewhere) it may be helpful for installation of a stabilizer to be relatively simple and easy to implement, e.g., without requiring modifications to an existing valve system or addition of extra components beyond a stabilizer body. Similarly, it may be useful to provide a versatile stabilizer design, which may be suitable for use with different types of valves and adaptable to various operational conditions.

Correspondingly, some examples of the disclosed technology can include a valve spindle stabilizer to improve the performance and reliability of valve monitoring systems (e.g., for valves instrumented with position sensors/transmitters). In some examples, a stabilizer body can include a threaded internal bore (e.g., at a bottom end of the body) that can be easily attached to external threads of an adjustment bolt of a valve. Such a feature can allow for easy installation and removal of the stabilizer, facilitating maintenance and retrofit operations to ensure optimal valve performance.

In some examples, a top part of the stabilizer includes a hole that allows a spindle to move up and down freely while restricting transverse (e.g., horizontal) play of the spindle. For example, a minimum inner diameter of a bore through a stabilizer body can be less than 10% larger than an outer diameter of a corresponding spindle. This general configuration, for example, can enhance the stabilizer's functionality by ensuring the spindle's unrestricted axial (e.g., vertical) movement, which may be of high importance for optimal operation of the valve operation. Further, the restriction in transverse (e.g., horizontal) movement, while eliminating undesirable transverse movements that can adversely affect the valve's performance and reliability. Relatedly, a stabilizer can be designed in some cases to restrict the horizontal (or other transverse) movement of the spindle without affecting the vertical (or other axial) movement. For example, a stabilizer can be configured with a clearance relative to a spindle that may increase the force required to move the spindle (to operate the valve) by 5% or less relative to a system without the stabilizer. Such configurations, for example, can help to ensure that the stabilizer provides the desired stabilizing effect while not interfering with the normal operation of the valve.

Generally, a stabilizer can prevent deflection of the spindle to a greater degree than a corresponding adjustment bolt or other valve component, thereby improving the repeatability of lift measurements. In particular, by reducing spindle play, a stabilizer can enhance the accuracy and repeatability of valve lift measurements (e.g., measurements of valve lift percentage) and thereby contribute to improved valve performance and monitoring (e.g., to identify need for maintenance).

In some examples, the disclosed technology also encompasses a valve assembly that incorporates a stabilizer. For example, an instrumented valve assembly can include a valve bonnet (or other support structure), a spindle disposed within the valve bonnet, and a spindle stabilizer that is secured relative to the valve bonnet (or other support structure) and slidingly receives the spindle. The stabilizer can thus guide axial movement of the spindle, to help achieve the aforementioned benefits in a fully integrated valve system.

In some examples, an adjustment body can be included in the valve assembly to change a spring force or other valve setting, and the stabilizer can be secured to the adjustment body. For example, an adjustment bolt to adjust a spring force of a spring-operated valve can include a threaded end that extends out of a valve bonnet (or other support structure) and the stabilizer can be threadedly secured to the threaded end of the adjustment bolt, to secure the stabilizer in alignment to guide movement of the spindle.

A valve assembly can in some cases include a magnetic target or other sensor target attached to the spindle (e.g., to a top of the spindle, outside of a valve bonnet and spaced axially apart from a stabilizer). The target can be aligned by the spindle to interact with a sensor (or a set of sensors) so that readings by the sensors in response to a position or movement of the target can indicate corresponding position or movement of the spindle. For example, the spindle may support the target so that detection of the target – and movement thereof – corresponds to non-contact detection of the spindle's position – and movement.

Correspondingly, some examples of the disclosed technology can include a digital position transmitter or other sensor configured to measure lift (e.g., lift percentage) based on detecting a position or movement of the target. For example, as noted above, detection of successive positions of the target may indicate corresponding successive positions of the spindle that supports the target and, thus, a present orientation of the valve assembly (e.g., as indicated by a lift height for a sealing element supported by the spindle). In this regard, as also noted above, the guiding structure of the stabilizer can help to ensure highly accurate and reliable measurement.

In some examples, the disclosed technology includes a method of stabilizing a valve spindle using a spindle stabilizer or a method of measuring valve lift with a stabilized spindle. For example, a method can involve attaching a stabilizer to a valve and guiding a movement of a spindle of the valve using the stabilizer. For example, a threaded bottom part of a stabilizer can be secured to an adjustment bolt or other component of a valve, and a top part of the stabilizer can slidingly guide axial movement of the spindle. With this arrangement in place, measurements of valve position can then be taken (e.g., over time, to monitor valve performance). Such approaches, for example, can provide a simple and effective approach to improving the repeatability of lift percentage measurements, thereby enhancing valve performance and monitoring.

Further embodiments of the disclosed technology can include a stabilizer with a detachable design, allowing the stabilizer to be easily removed from a valve (e.g., for replacement or other maintenance) as well as easily attached. A threaded or other detachable design, for example, can thus facilitate improved maintenance or retrofit operations and can also enable the use of the stabilizer with different valves, enhancing overall versatility. In particular examples, as also generally discussed above, a stabilizer may be threaded internally to receive a threaded end of an adjustment bolt (or other threaded portion of a valve) and may include a through-hole to receive a spindle. Such an approach, for example, may allow for high versatility and ease of implementation for attachment of the stabilizer to existing valve assemblies (e.g., in retrofit installations).

The examples of the FIGS. are illustrated with an axial direction of a spindle aligned vertically. Lateral (or, generally, transverse) play of the spindle – e.g., as reduced by the illustrated stabilizers – may correspondingly include movement in a horizontal direction. Accordingly, for convenience, some discussion herein refers to vertical and horizontal movements or restrictions on movement. Unless expressly indicate to the contrary, other examples may exhibit directions for operative movements, including for axial spindle movement for valve opening and closing and for transverse spindle deflection (e.g., with corresponding non-vertical and non-horizontal directions, respectively).

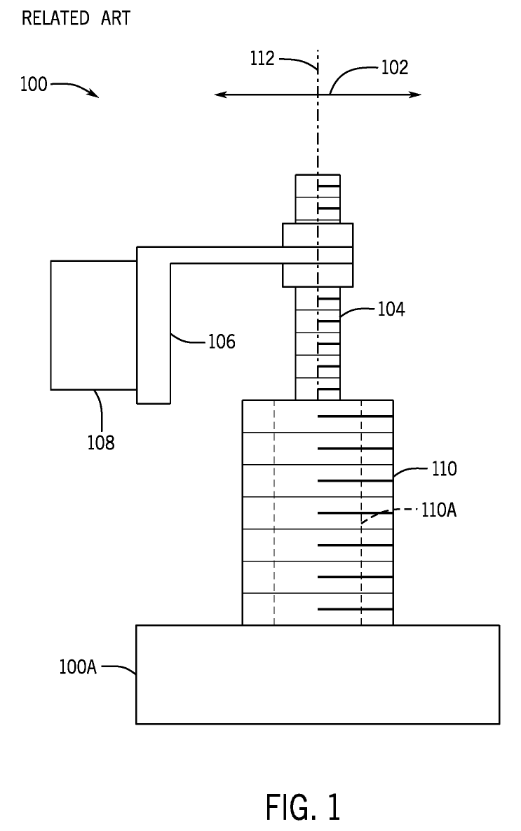

FIG. 1 of the drawings depicts a valve 100 with a spindle 104 that may exhibit significant transverse play during operation. In particular, the spindle 104 may be subject to play in a lateral (e.g., horizontal) direction, deviating from an axial direction 112 as indicated by arrows 102. As generally discussed above, this deviation can negatively affect lift percentage measurements by misaligning the spindle relative to a sensor arrangement.

In particular, during operation, the spindle 104 can move vertically within the valve bonnet to adjust the lift of the valve 100 and thus control fluid flow through the valve 100. In the illustrated example, the spindle 104 can be guided by an adjustment bolt 110 that is threadedly engaged with a valve bonnet 100A of the valve 100. For example, the bolt 110 can be threadedly adjustable to change a compression of a spring (not shown) to change a set pressure of the valve 100.

Notably, a diameter of an internal bore 110A of the bolt 110 may provide a relatively large clearance relative to the diameter of the spindle 104 as compared to stabilizers in other examples presented herein. Thus, although the bolt 110 can usefully provide some support for the spindle, the relatively large bore 110A may still allow relatively large lateral play of the spindle 104, both when the spindle 104 is at rest and during axial movement (e.g., to open or close the valve 100).

The spindle 104 is connected to a magnetic target 108 (e.g., by a bracket 106) that can be detected by a digital positioner transmitter (not shown in FIG. 1) to measure the position of the spindle 104 and thus the lift of the valve 100 (e.g., the lift percentage, relative to maximum lift). For example, the position transmitter (not pictured) can interpret variations in a magnetic field to determine the position of the spindle 104 and the lift percentage of the valve 100 can be determined (e.g., calculated) accordingly. However, the play of the spindle in the axial direction 112 can correspond to unwanted lateral movement of the target 108 (perpendicular to the axial direction) – potentially amplified by deflection at the lever-arm offset distance of the spindle target 108 from the spindle 104 – and corresponding inaccuracies in lift measurements taken using a corresponding sensor (not shown in FIG. 1).

To address these issues, as also discussed above, examples of the disclosed technology can include a spindle stabilizer. For example, a stabilizer can guide axial movement of the spindle with a reduced-diameter clearance as compared to other components that slidingly support the spindle, thereby effectively reducing spindle play in a lateral direction. In some examples, a spindle stabilizer can include a body with internal threads (e.g., on a bottom portion of the body) that can be easily screwed onto an adjustment bolt or other threaded portion of a valve assembly. Further, the body can include an inner diameter (e.g., at a top portion of the body) that allows axial movement of the spindle while restricting lateral movement (e.g., with greater restriction than is imposed by a corresponding adjustment bolt). Such a design, for example, can improve the repeatability of the lift percentage measurement, thereby helping to improve the overall monitoring and performance of the valve.

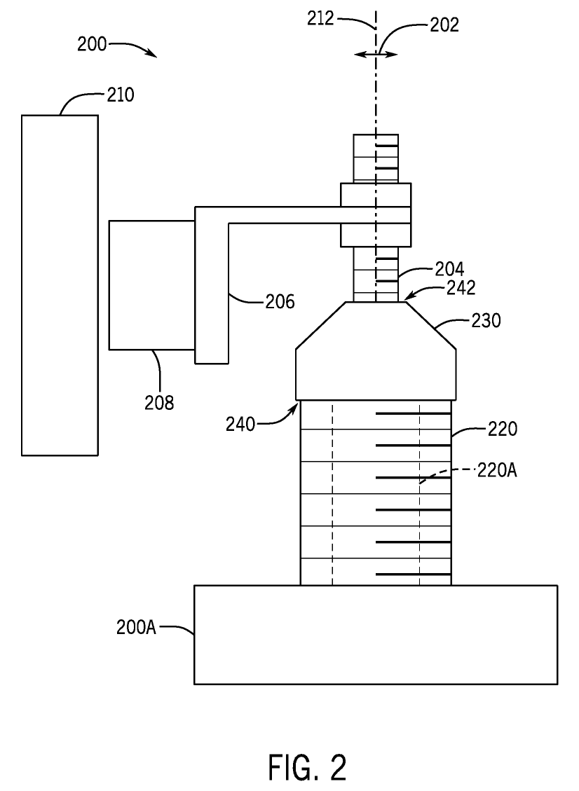

FIG. 2 presents an example valve 200, illustrated in partial view, that includes a spindle stabilizer assembly according to an example of the disclosed technology. As further detailed below, such an assembly can provide a supplemental guide for the valve spindle, to reduce lateral play that may negatively affect accuracy and repeatability of lift measurements.

In particular, FIG. 2 illustrates a spindle stabilizer 230 installed for operation with the valve assembly 200. Similarly to the valve assembly 100, the valve assembly 200 includes a valve bonnet 200A, a spindle 204 disposed within the valve body, and an adjustment bolt 220 coupled to the valve bonnet 200A and including an internal bore 220A with a diameter that is relatively large compared to the diameter of the spindle 204.

As illustrated, the spindle stabilizer 230 is attached to the adjustment bolt (e.g., threadedly engaged with an outer diameter thereof) to receive the spindle 204 in alignment with the bolt 220. In particular the spindle 204 extends through first and second holes 240, 242 of the stabilizer 230 for axial movement of the spindle 204. For example, the first hole 240 may have a relatively large diameter to easily receive the spindle 230 whereas the second hole 242 may have a relatively small diameter to block angular deflection of the spindle 230 (e.g., to prevent angular deflection beyond a particular angle).

Thus, the spindle stabilizer 230 can guide movement of the spindle 204 along an axial direction 212 (e.g., in combination with the bolt 220). Further, as compared to designs that include the bolt 220 alone, or other conventional designs, the spindle stabilizer 230 can notably reduce lateral movement of the spindle 204 (e.g., as indicated by arrows 202) to enhance stability during operation. In the illustrated installation, the spindle stabilizer 230 guides the spindle 204 from the top of the spindle stabilizer 230 (opposite the valve bonnet 200A), although other arrangements are possible.

Due to the arrangement of the stabilizer 230, during operation of the valve a sensor target 208 attached to the spindle 204 may experience relatively little lateral deflection, as compared to the sensor target 108 of FIG. 1. In the example shown, the sensor target 208 is a magnetic target and is attached to the spindle 204 by a bracket 206 (e.g., to be sensed by a Hall effect sensor or other magnetic sensor assembly), although other configurations are possible.

Thus, measurements of the position of the spindle 204 by a position transmitter 210 (or other sensor) may be significantly more accurate and repeatable for the valve 200 than for the valve 100. For example, in testing on a conventional configuration without a stabilizer, measurements of position of the valve 100 can be observed to exhibit fluctuations of +/- 20% relative to the calibrated span at which the valve 100 would reseat after a lift event. Thus, the measured position may significantly deviate from an actual position of the valve. In contrast, after the installation of the stabilizer 230, measurements of valve reseat were consistently within +/- 1% of the calibrated span, corresponding to a significant increase in accuracy and repeatability. Further, this improvement may not only enhance the efficiency of operation of the valve 200 overall, but also contribute to generally reduced maintenance costs over time (e.g., by more accurately indicating potential valve degradation or failure). The disclosed technology can thus provide a cost-effective and efficient solution to the problem of spindle play in instrumented (or other) valve systems.

In some examples, a spindle stabilizer can be selectively attached or detached to or from an adjustment bolt, respectively (e.g., for maintenance or retrofit operations). Among other benefits, this aspect can add to the versatility and ease of use of the spindle stabilizer. Further, in some examples, inclusion of commonly used attachment structures on a spindle stabilizer can allow the spindle stabilizer to be used across a variety of valve types and applications (e.g., with internal threading on a spindle stabilizer being engageable with external threading on adjustment bolts for a wide range of valve configurations).

In some examples, a spindle stabilizer can be configured to guide a spindle without requiring any additional components. For example, a spindle stabilizer can directly engage a spindle at an inner diameter of the spindle stabilizer to simultaneously (directly) guide axial movement of the spindle and block an angular deflection of the spindle (e.g., may limit angular deflection to below a threshold by blocking a corresponding lateral movement past a particular lateral deflection distance). This design, for example, can simplify the corresponding valve assembly and reduce the complexity of installation and operation.

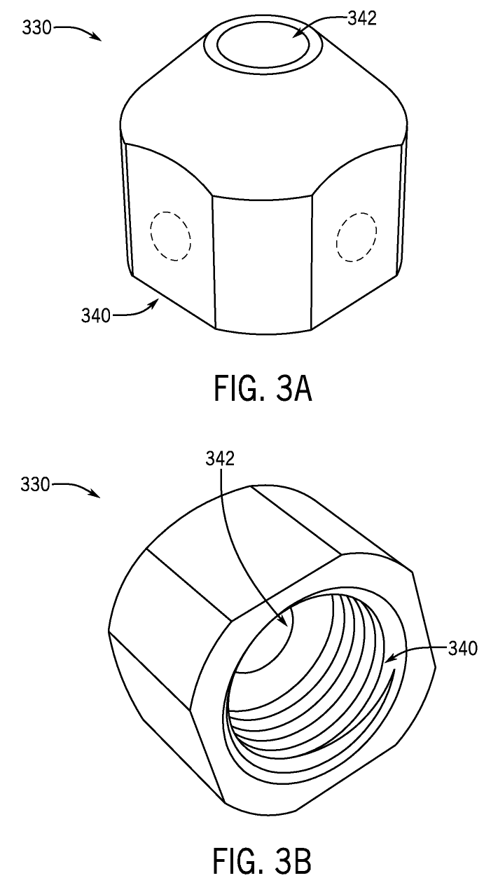

An example spindle stabilizer 330 is illustrated in FIGS. 3A and 3B, which may be a particular implementation of the spindle stabilizer 230 of FIG. 2. Correspondingly, discussion of numbered components above also applies to similarly numbered components below unless otherwise indicated (e.g., for the stabilizers 230, 330 generally, as well as specific numbered features thereof). In particular, the stabilizer 330 has an integrally formed body with an internal bore that can receive an adjustment screw and a spindle, and that defines larger and smaller openings 340, 342 at opposed axial ends. Further, the bore includes internal threads at a first (e.g., bottom) axial end of the body, and a reduced-diameter portion at a second (e.g., top) axial end of the body. Thus, for example, the stabilizer 330 can be easily threaded onto external threads of an adjustment bolt or other valve component to align the reduced-diameter portion of the bore with a corresponding spindle and thus guide movement, and limit deflection, of the spindle. In some examples, as also further discussed below, a stabilizer can include openings for set screws to help further secure the stabilizer (e.g., as indicated with dashed lines in FIG. 3A).

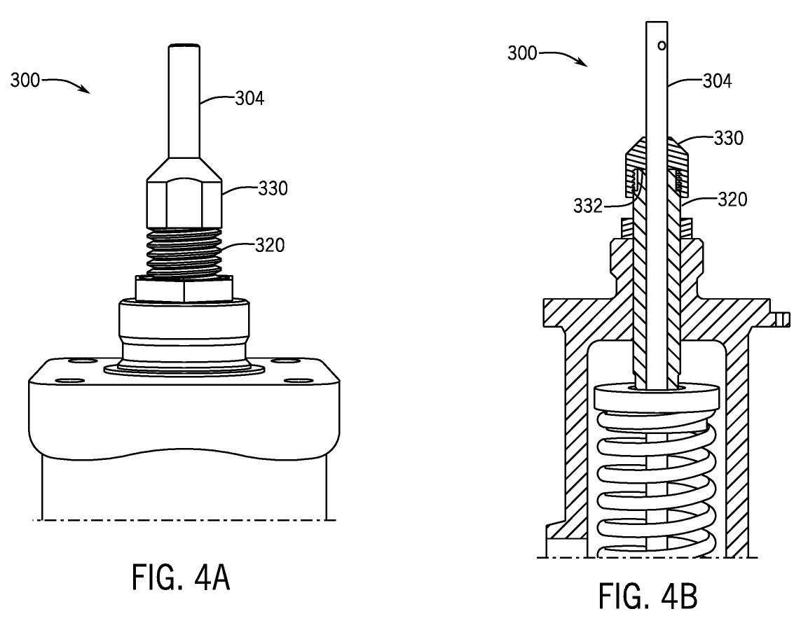

FIGS. 4A and 4B illustrate the stabilizer 330 installed onto a valve 300 (e.g., an example configuration of the valve 200 of FIG. 2), as part of a valve assembly. As shown, the stabilizer 330 can be threadedly secured to external threads of an adjustment bolt 320, and a spindle 304 can extend through the stabilizer 330 and the bolt 320. Accordingly, the stabilizer 330 and the bolt 320 can guide axial movement of the spindle 304, and the stabilizer 330 in particular can limit lateral movement of the spindle 304 (e.g., for improved measurement of valve lift, as further discussed above). Further, as shown in FIG. 4B, an internal shoulder 332 on the stabilizer 330 (e.g., at an axial end of the internal threads) can provide a seating feature to define an installed position of the stabilizer 330.

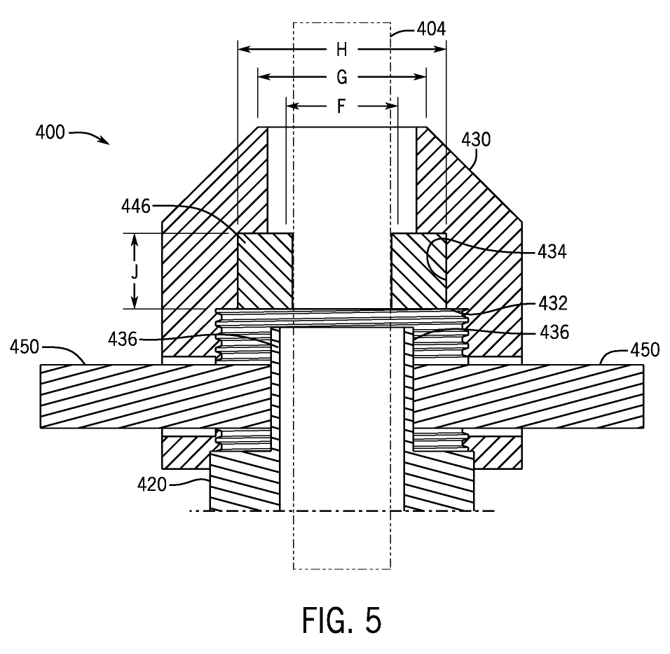

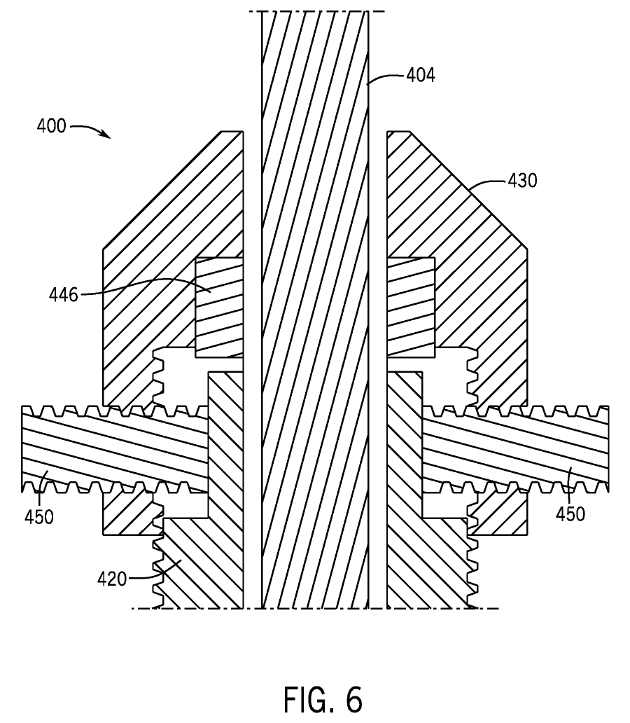

FIG. 5 illustrates another example spindle assembly 400, which can be used with the valves 200, 300 as generally discussed for other examples above. A more general schematic illustration of the assembly 400 is also presented in FIG. 6 (e.g., as oriented during installation of a stabilizer 430). The spindle assembly 400 is similar to the spindle assemblies of FIGS. 2, 4A, and 4B and discussion of the operation of similarly numbered or named parts for those examples thus also applies to the examples of FIGS. 5 and 6, unless otherwise indicated. Correspondingly, for example, discussion above of the stabilizers 230, 330 also applies to the stabilizer 430 (and vice versa), aside from certain differences further detailed below. Similarly, discussion above of the spindles 204, 304 and the adjustment bolts 220, 320 also applies to a spindle 404 and an adjustment bolt 420 of the assembly 400 (and vice versa).

One difference between the spindle assembly 400 of FIGS. 5 and 6 and the examples discussed above is that the stabilizer 430 is configured to receive and retain an insert 446 that contacts and guides the spindle 404 during operation (e.g., at a location that is spaced axially from an adjustment screw or other valve structure, or that provides a reduced diameter passage for the stabilizer 430 relative to an adjustment screw or other proximal valve structure). Correspondingly, in the example illustrated, the stabilizer 430 also provides a larger clearance between the stabilizer 430 and the spindle 404 than is provided between the insert 446 and the spindle 404. For example, as illustrated in FIG. 5, an inner diameter F of the insert 446 may be larger than an outer diameter of the spindle 404 (not labeled), but smaller than an adjacent inner diameter G of the stabilizer 430, so that the insert 446 protrudes radially inwardly of the stabilizer 430 to contact and guide the spindle 404.

In some examples, the insert 446 can be formed of relatively low friction material (e.g., PTFE or other composites), to provide a relatively low friction contact surface that allows the spindle 404 to slide freely for operation while maintain appropriate lateral stability (e.g., for sensing, as discussed above). In this regard, for example, use of the insert 446 can allow the stabilizer 430 to be formed from relatively robust materials (e.g., metal) without risk of galling between the stabilizer 430 and the spindle 404 or other adverse interactions that may result in loss of lift.

In some examples, the stabilizer 430 can include particular contours to secure an insert. For example, as also shown in FIG. 5, the stabilizer 430 can include an internal groove or recess 434 of diameter H and height J, which may receive and retain the insert 446. In some cases, as shown, a shoulder of the groove can secure (e.g., compress) the insert against an end of the adjustment bolt 420 (e.g., with a compression depth set by contact of an axially spaced shoulder 432 with the adjustment bolt 420). However, other retention methods are possible (e.g., retainer rings, adhesives, external fasteners, etc.).

In some examples, other stability features can be provided. For example, pins or other bodies can be inserted through the stabilizer 430 to engage the adjustment bolt 420 (or other supporting structure) and thereby further secure and stabilize the stabilizer 430 relative to the valve and a corresponding transmitter (see, e.g., FIG. 2). For example, as shown in FIGS. 5 and 6, set screws 450 can extend through corresponding openings on the stabilizer 430 to engage flats 436 (or other features) of the adjustment bolt 420. Thus, the screws 450 can be tightened to help prevent loosening of the stabilizer 430, including in potentially high-vibration or thermally-cycled environments. Further, engagement by the screw 450 or other similar components can also generally reduce vibrational noise during operation and thus improve accuracy for measurements with a corresponding transmitter.

Although not expressly shown in FIG. 5, some examples can include the flats 436 over only part of a circumference of a relevant body. Thus, for example, some configurations of FIG. 5 can also engage the internal threads of the stabilizer 430 at locations that are axially aligned (i.e., offset only circumferentially) from the flats 436.

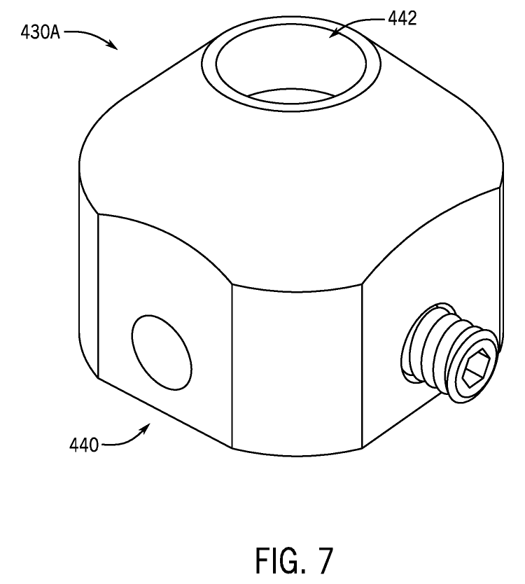

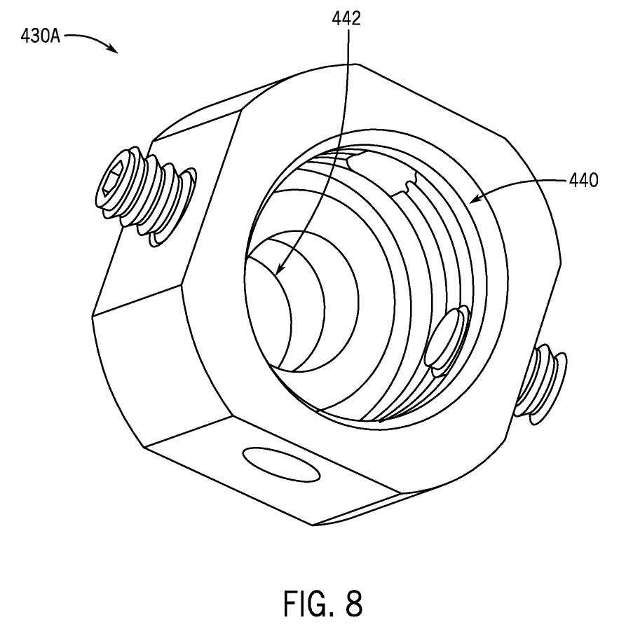

In some examples, openings to receive set screws or other pins can be provided in an array around an outer perimeter of the stabilizer 430 (e.g., with a regular offset). For example, an array of openings with an offset of 90 degrees is shown in dashed lines in FIG. 3A. Similar openings are also shown on an example stabilizer collar 430A in FIGS. 7 and 8, which is an example configuration of the stabilizer 430 of FIGS. 5 and 6. Such a configuration, for example, can allow for more adaptable and secure installation.

Thus, as also noted above, some embodiments of the invention can include a stabilizer to provide improved valve operation and improved monitoring of lift position. Further, embodiments of the invention can include a valve assembly that incorporates a stabilizer (e.g., with a valve bonnet, a spindle disposed to move within the valve bonnet, an adjustment bolt coupled to the valve bonnet, and a spindle stabilizer attached to the adjustment bolt to receive the spindle). The stabilizer in this assembly guides the spindle, thereby achieving the aforementioned benefits within a fully integrated valve system.

Further embodiments of the invention can include a method of stabilizing a valve spindle using the spindle stabilizer or a corresponding method of measuring valve lift. For example, a spindle stabilizer can be threadedly attached (e.g., in a retrofit operation) to an adjustment bolt or other component of a valve, with the stabilizer in alignment to guide a spindle of the valve (e.g., at a reduced-diameter portion of an internal bore of the spindle stabilizer), and the valve can then be operated to move the spindle, as guided and supported by the stabilizer. Further, during the stabilized movement of the spindle, position or other measurements can be taken to monitor valve operation. Such a method can provide a simple and effective approach to enhancing the repeatability of lift percentage measurements, thereby enhancing valve performance.

In conclusion, examples of the disclosed valve spindle stabilizer technology, including associated valve assemblies and methods, represent significant advancements in the field of valve technology. For example, by guiding a spindle with reduced lateral deflection, examples of the disclosed technology can improve the repeatability of lift measurements, to enhance the performance and reliability of a wide variety of valves.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screws, other fasteners, or adhesive to hold separately formed pieces together, is an integral (and integrally formed) element. In contrast, an element formed from multiple pieces that are separately formed initially then later fastened together, is not an integral (or integrally formed) element.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

1. A spindle stabilizer for a valve, the spindle stabilizer comprising:
a threaded body configured to be screwed onto the valve;
the threaded body having a first hole configured to receive a spindle of the valve for axial movement of the spindle; and
the threaded body including a second hole configured to receive the spindle for axial movement of the spindle,
the second hole having a smaller hole diameter relative to the first hole so that, during axial movement of the spindle within threaded body, the threaded body blocks angular deflection of the spindle at the second hole.

2. The spindle stabilizer of claim 1, wherein the threaded body is open at a bottom end to engage the valve and second hole is positioned at a top end of the threaded body.

3. The spindle stabilizer of claim 1, wherein the axial movement of the spindle includes vertical movement of the spindle.

4. The spindle stabilizer of claim 1, further comprising:
an insert retained by the threaded body, wherein the insert extends radially inward beyond an inner diameter of the threaded body to define the second hole.

5. The spindle stabilizer of claim 1, wherein the threaded body is configured to be screwed onto an adjustment bolt of the valve to receive the spindle.

6. The spindle stabilizer of claim 5, wherein the threaded body supports set screws that extend laterally through the threaded body to further secure the threaded body onto the adjustment bolt.

7. A valve assembly, comprising:
a valve bonnet;
an adjustment bolt coupled to the valve bonnet;
a spindle that is axially movable within the valve bonnet and the adjustment bolt; and
a spindle stabilizer secured to the adjustment bolt to guide axial movement of the spindle,
the spindle stabilizer including a stabilizer body that is secured to the adjustment bolt and receives the spindle for axial movement through the stabilizer body, and
the stabilizer body contacting the spindle, spaced axially apart from the adjustment bolt, to block angular deflection of the spindle.

8. The valve assembly of claim 7, further comprising:
a sensor target attached to the spindle; and
a sensor arranged to sense the sensor target to measure a position or a movement of the spindle.

9. The valve assembly of claim 8, further comprising:
a control system configured to measure a valve lift of the valve assembly based on the sensing of the sensor target by the sensor.

10. The valve assembly of claim 9, wherein the control system includes a digital position transmitter configured to measure the valve lift based on readings from the sensor.

11. The valve assembly of claim 8, wherein the sensor target is a magnetic target that includes a magnetic array configured to detected by a Hall effect sensor.

12. The valve assembly of claim 7, wherein the spindle stabilizer is secured to the adjustment bolt at a bottom portion of the spindle stabilizer; and
wherein the spindle stabilizer blocks angular deflection of the spindle at a top portion of the spindle stabilizer.

13. The valve assembly of claim 12, wherein the spindle stabilizer blocks the angular deflection by blocking horizontal deflection of the spindle.

14. The valve assembly of claim 7, wherein the spindle stabilizer is detachable from the adjustment bolt.

15. The valve assembly of claim 7, wherein the spindle stabilizer is configured to guide the spindle directly.

16. The valve assembly of claim 7, further comprising:
set screws extending through the spindle stabilizer to engage the adjustment bolt.

17. A method of instrumenting a valve, the method comprising:
providing a spindle stabilizer that includes a threaded body configured to be screwed onto the valve, the threaded body having a first hole that receives a spindle of the valve for axial movement of the spindle, and a second hole that receives the spindle for axial movement of the spindle, the second hole having a smaller hole diameter than the first hole; and
threadedly attaching the spindle stabilizer to the valve so that the spindle is received through the first and second holes and the spindle stabilizer blocks angular deflection of the spindle at the second hole during axial movement of the spindle.

18. The method of claim 17, further comprising:
aligning a magnetic target secured to the spindle with a sensor configured to detect the magnetic target to measure lift of the valve.

19. The method of claim 17, wherein the spindle stabilizer is aligned so that axial movement of the spindle through the spindle stabilizer corresponds to vertical movement of the spindle.

20. The method of claim 17, wherein the spindle stabilizer is threadedly attached to the valve at an adjustment bolt of the valve that slidingly receives the spindle; and
wherein threadedly attaching the spindle stabilizer to the adjustment bolt aligns the spindle stabilizer to guide the spindle at a top portion of the spindle stabilizer that is spaced axially apart from the adjustment bolt.
